(19) United States
(12) Patent Application Publication
(10) Pub. No.: US 2015/0290833 A1
(43) Pub. Date: Oct. 15, 2015

(54) CHAIN AND CHAIN TOOL

(71) Applicant: TOOLGAL DEGANIA INDUSTRIAL DIAMONDS LTD., Degania A, (IL)

(72) Inventors: Genadi Rabinovich, Tiberias (IL); Ran Gur, Shimshit (IL); Vladimir Volokh, Naharia (IL)

(21) Appl. No.: 14/646,001

(22) PCT Filed: Nov. 2, 2013
(86) PCT No.: PCT/IL2013/050899

§ 371 Date: May 19, 2015

(30) Foreign Application Priority Data
Nov. 20, 2012 (IL) 223165
Sep. 11, 2013 (IL) 228342

(51) Int. Cl. B27C 1/04; B23D 13/00; B23D 7/00; F16G 15/08; F16G 13/18

(52) U.S. Cl. CPC B27C 1/04; F16G 15/08; F16G 13/18; B23D 7/00; B23D 13/00

(57) ABSTRACT

The present invention discloses a chain tool for chip removing and/or shredding. The chain tool comprises a tool body having a longitudinal axis, and a chain arranged about the tool body and comprising chain members consecutively linked therebetween. The tool body comprises a generally axi-symmetric envelope extending about the longitudinal axis and disposed between generally radially-extending coaxially-aligned first and second ends of the tool body. The tool body further comprises a plurality of channels circumferentially defined on the envelope. The chain members are disposed on the plurality of channels about the envelope and are configured to spiral circumferentially about the tool body from the first end to the second end.

### CROSS-REFERENCE TO RELATED APPLICATIONS

This application claims priority from co-pending Israeli Application IL/223165 filed on November 20.

### FIELD OF THE INVENTION

The present invention relates generally to chains, designed to move and/or remove material, as well as to a chain tool.

### BACKGROUND OF THE INVENTION

Examples and limitations related therewith brought herein below are intended to be illustrative and not exclusive. Other limitations of the related art will become apparent to those of skill in the art upon a reading of the specification and a study of the figures. An illustrative example of a chain used for cutting is a well-known chain-saw. However, such exemplary and illustrative purpose, and the related description and drawings herein, should be interpreted by way of illustrative purpose without limiting the scope of the present disclosure. Other types of chains and/or uses may well be considered as applicable for the utilization of the presently disclosed invention.

One exemplary use of chains is to remove material, as disclosed in, for example, U.S. Pat. No. 5,215,072, disclosing, inter alia, “ . . . an abrasive particle impregnated mesh on an inclined surface and on select areas of its side skirts. The skirts cover as least a portion of the bores in the drive links and support links to retain and protect the fasteners therein.”

Thus, it may be advantageous to have a chain that may offer enhance performance and/or fewer parts. Numerous other advantages and features of the present invention may become readily apparent from the following detailed description of the invention and the embodiment thereof, from the claims and from the accompanying drawings.

### SUMMARY

In the following disclosure, aspects thereof are described and illustrated in conjunction with systems and methods which are meant to be exemplary and illustrative, not limiting in scope. The present disclosure may be further directed to a method of utilization and/or usage of such apparatuses

Accordingly, it is an object of the present invention to provide a novel, highly modular, chain tool having easy and simple-to-manufacture chains and/or tool bodies.

One aspect of the present invention generally concerns a chain tool for chip removing and/or shredding. The chain tool comprises a tool body having a longitudinal axis, and a chain arranged about the tool body and linked there between. The tool body comprises a generally axi-symmetric envelope extending about the longitudinal axis and disposed between generally radially-extending coaxially-aligned first and second ends of the tool body. The tool body further comprises a plurality of channels circumferentially defined on the envelope. The chain comprises a plurality of chain members consecutively linked therebetween and disposed on the plurality of channels such that the chain members are configured to be placed one after the other circumferentially while advancing axially, i.e., to spiral circumferentially about the tool body, but not necessarily by equal increments, from the first end to the second end.

Potentially, each of the chain members comprises a substantially arcuate basal face configured to rest upon the plurality of channels.

Potentially further, the plurality of channels comprises a plurality of ridge faces, and a plurality of groove faces, wherein the ridge faces and the groove faces alternate with each other.

Moreover, the plurality of chain members comprises at least one keel member, and at least one rider member linked to the keel member, wherein the keel members and the rider members alternate with each other, and wherein the rider members and the keel members abut the ridge faces and the groove faces respectively.

Optionally, a diameter of the groove face is less than a diameter of an adjacent ridge face.

Further, a width of the keel member and a width of the rider member correspond to a width of the ridge face and a width of the groove face, respectively.

Alternatively, the keel members and the rider members are linked by connectors such that a depth of the keel members measured from a center of the connectors to a basal face of the keel members is less than a depth of adjacent rider members measured from the center of the connectors to a basal face of the rider members.

Potentially, each of the chain members comprises first and second sidewalls disposed substantially parallel to each other, an outer side and an inner side laterally disposed to the first and second sidewalls, and a pair of connectors disposed between the outer and inner sides, wherein a first connector is disposed adjacent to the first sidewall and a second connector is disposed adjacent to the second sidewall.

Possibly, the connectors are swivel connectors configured to allow swivel movement between adjacent chain members.

Optionally, the channels of the tool body comprise alternating peaks and troughs linked by sloping sidewalls such that the alternating peaks and troughs are configured to define a generally triangular, generally trapezoidal, and/or generally sinusoidal, i.e., a sloped profile in a circumferential cross-section of the tool body.

Further, each of the chain members may comprise a basal face including a first slant face, and a second slant face disposed in a generally opposing relation to the first slant face such that the first and second slant faces are configured to rest upon the sloping sidewalls of the tool body. Furthermore, each of the chain members may comprise a keel edge defined at an intersection of the first and second slant faces such that the keel edge is configured to rest upon one of a peak and a trough of the tool body.

Potentially, a pitch defined between adjacent channels of the tool body is one of equal and unequal, wherein a length of the individual chain members is one of equal and unequal to correspond with the pitch between the channels of the tool body.

Potentially, the tool body is modular and comprises alternating and interfitting ridge rings and groove rings.

Potentially, an outer side of at least one chain member defines an appendage adapted to accommodate a tool member.

Possibly, two or more tool members on consecutive chain members define a tool configured to perform at least one of cutting, shredding, milling, broaching, and/or grinding.

Another aspect of the present invention concerns a chain adapted to cooperate with a chain tool, the chain tool comprising alternate groove faces and ridge faces. The chain comprises a plurality of chain members consecutively linked to each other. The chain members comprises at least one keel member, and at least one rider member linked to the keel member, wherein the keel members and the rider members alternate with each other to abut the ridge faces and the groove faces of the tool respectively.

Possibly, the keel members and the rider members are linked by connectors such that a depth of the keel members measured from a center of the connectors to a basal face of the keel members is less than a depth of adjacent rider members measured from the center of the connectors to a basal face of the rider members.

Potentially, each of the chain members comprises a substantially arcuate basal face, the basal face comprising a plurality of ridge faces and groove faces, wherein the ridge faces of the chain members are configured to engage with one or more groove faces of the chain tool, and wherein the groove faces of the chain members are configured to engage with one or more ridge faces of the chain tool.

Potentially, the outer side of at least one chain member defines an appendage adapted to accommodate a tool member.

Possibly, a length of the keel member is greater than a length of the rider member.

Alternatively, the length of the keel member is lesser than the length of the rider member.

Potentially, each of the chain members comprises first and second sidewalls disposed substantially parallel to each other, an outer side and an inner side laterally disposed to the first and second sidewalls, and a pair of connectors disposed between the outer and inner sides, wherein a first connector is disposed adjacent to the first sidewall and a second connector is disposed adjacent to the second sidewall.

Possibly, the connectors are swivel connectors configured to allow swivel movement between adjacent chain members.

Potentially, in pursuance of another aspect of the present invention, a tool body of a chain tool comprises a plurality of channels including alternating peaks and troughs linked by sloping sidewalls such that the alternating peaks and troughs are configured to define a generally triangular, generally trapesoidal, and/or generally sinusoidal, i.e., a sloped rofile profile in a circumferential cross-section of the tool body. The tool body further employs the chain and is characterized in that the chain is configured to adapt for fitment and use on the tool body.

Possibly, each of the chain members may comprise a basal face including a first slant face, and a second slant face disposed in opposing relation to the first slant face such that the first and second slant faces are configured to rest upon the sloping sidewalls of the tool body. Furthermore, each of the chain members may comprise a keel edge defined at an intersection of the first and second slant faces such that the keel edge is configured to rest upon one of a peak and a trough of the tool body.

Potentially, a length of the individual chain members are one of equal and unequal to correspond with a pitch defined between adjacent channels of the tool body.

In addition to the exemplary aspects and embodiments described above, further aspects and embodiments will become apparent by reference to the accompanying figures and by study of the following detailed descriptions.

Other features and aspects of this disclosure will be apparent from the following description and the accompanying drawings.

### BRIEF DESCRIPTION OF THE DRAWINGS

Exemplary and/or illustrative embodiments of the present invention will be presented herein below in the following figures, by way of example only. The present invention may be best understood from the following detailed description when read in connection with the accompanying drawings. In the drawings, like members have the same reference numerals. When pluralities of similar members are present, a single reference numeral may be assigned to each plurality of similar members with a small letter designation referring to specific members. When referring to the members collectively or to a non-specific one or more of the members, the small letter designation may be eliminated. It should be emphasized that according to common practice, various features of the drawings are not drawn to scale unless otherwise indicated. Dimensions of various features may be expanded and/or reduced and/or roughly shown and/or omitted entirely, to show details of particular components, for the purpose that the present disclosure may become more fully understood from the detailed description and the accompanying schematic figures.

Reference will now be made to the accompanying drawings, in which:

FIG. 1 shows a schematic general perspective representation of an exemplary embodiment of a chain tool comprising a tool body accommodating a plurality of a schematic, representative embodiment chain members;

FIG. 2 shows a schematic general perspective representation of the tool body of an exemplary embodiment of the chain tool of FIG. 1;

FIG. 3 shows a schematic general perspective representation of a modified embodiment of a chain tool accommodating a plurality of a schematic, representative embodiment chain members;

FIG. 4A and FIG. 4B schematically illustrates a convex and a concave optional embodiments to the general shape of the tool body;

FIG. 5A and FIG. 5D schematically illustrates alternative embodiments of channels on the tool body;

FIG. 6 shows a schematic general perspective representation of an exemplary first embodiment of a chain according to the present invention in an elevation view;

FIG. 7 illustrates a front view of the first embodiment of the chain of FIG. 2;

FIG. 8 shows a top view of the first embodiment of the chain of FIG. 2;

FIG. 9 shows a schematic general perspective representation of an exemplary second embodiment of a chain according to the present invention;

FIG. 10 shows a schematic general perspective representation of an exemplary third embodiment of a chain according to the present invention;

FIG. 11 shows a schematic general perspective representation of an exemplary fourth embodiment of a chain according to the present invention;

FIG. 12 shows a schematic general perspective representation of an exemplary fifth embodiment of a chain member according to the present invention;

FIG. 13A to FIG. 13D show a schematic general representation of an exemplary sixth embodiment of a chain member, showing a face view (A), an elevation view (B), a plan view with a partial section view (C) and a perspective view (D);

FIG. 14 show a schematic general representation of an exemplary sixth embodiment of a chain comprising a plurality of the exemplary sixth embodiment chain member shown on FIGS. 13A to 13D;

FIG. 15 show a schematic general representation of a perspective view of an exemplary particular embodiment of a chain tool accommodating a plurality of sixth embodiment chain members wrapped thereabout;

FIG. 16 shows a schematic general perspective representation of an alternative exemplary embodiment of a chain tool comprising an alternative tool body accommodating a plurality of a schematic, representative embodiment chain members;

FIG. 17A to FIG. 17F show a variety of different, exemplary embodiments which illustrate some of the wide variety of different embodiments pertaining to the present invention;

FIG. 18 shows a schematic top perspective view of an exemplary seventh embodiment chain member adapted to be accommodated on the alternative embodiment of the chain tool shown on FIG. 16;

FIG. 19 shows a schematic bottom perspective view of the exemplary seventh embodiment chain member shown on FIG. 18;

FIG. 20 shows a schematic side view of the exemplary seventh embodiment chain member shown on FIG. 18;

FIG. 21 shows a schematic top view of the exemplary seventh embodiment link shown on FIG. 18;

FIG. 22 shows a schematic axial section view of the exemplary seventh embodiment chain member shown on FIG. 18 taken along lines XXII-XXII in FIG. 20;

FIG. 23 shows a schematic perspective view of an exemplary eighth embodiment of a plurality of chain members adapted to the alternative exemplary tool body of FIG. 16;

FIG. 24 shows a schematic perspective view of an exemplary ninth embodiment of a plurality of chain members adapted to the alternative exemplary tool body of FIG. 16;

FIG. 25 shows a schematic perspective view of an exemplary link attachment means;

FIG. 26 shows a schematic top view of the exemplary link attachment means of FIG. 25; and

FIG. 27 shows a schematic, multiple tool bodies and multiple chain members of respective chain tools arranged to work in combination.

### DETAILED DESCRIPTION

As required, a schematic, exemplary embodiment of the present chain and chain tool are disclosed herein, however, it is to be understood that the disclosed embodiments are merely exemplary of the present disclosure, which may be embodied in various and/or alternative forms. Specific structural and functional details disclosed herein are not to be interpreted as limiting, but merely as a basis for the claims and as a representative basis for teaching one skilled in the art to variously employ the present disclosure in virtually any appropriately detailed structure.

Aspects, advantages and/or other features of exemplary embodiments of the invention will become apparent in view of the following detailed description, which discloses various non-limiting embodiments of the invention. In describing exemplary embodiments, specific terminology is employed for the sake of clarity. However, the embodiments are not intended to be limited to this specific terminology. It is to be understood that each specific member includes all technical equivalents that operate in a similar manner to accomplish a similar purpose.

Exemplary embodiments may be adapted for many different purposes and are not intended to be limited to the specific exemplary purposes set forth herein. Other non-limiting examples of such embodiments are compositions that may be used, for example, for structural components. Those skilled in the art would be able to adapt the embodiments of the present disclosure, depending for example, on the intended use of the embodiment.

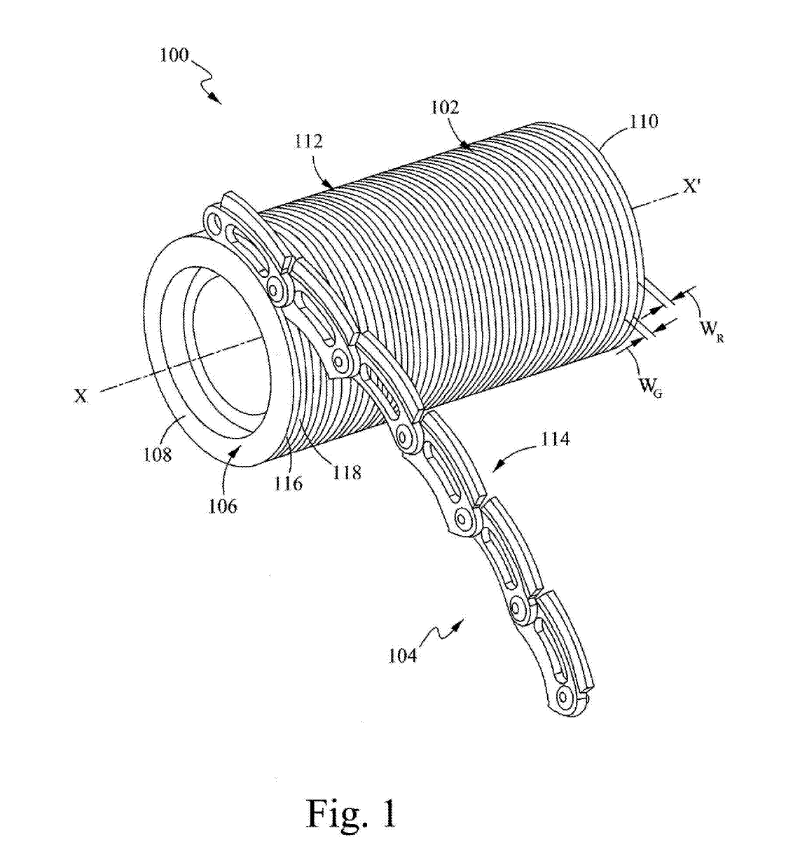

Chain members for moving and/or removing material are generally designed to be used in association with a chain tool. An exemplary embodiment of such a chain tool 100 is shown on FIG. 1. The exemplary embodiment chain tool 100 comprises a tool body 102 having a longitudinal axis X-X′, and a chain 104 arranged about the tool body 102 and linked therebetween.

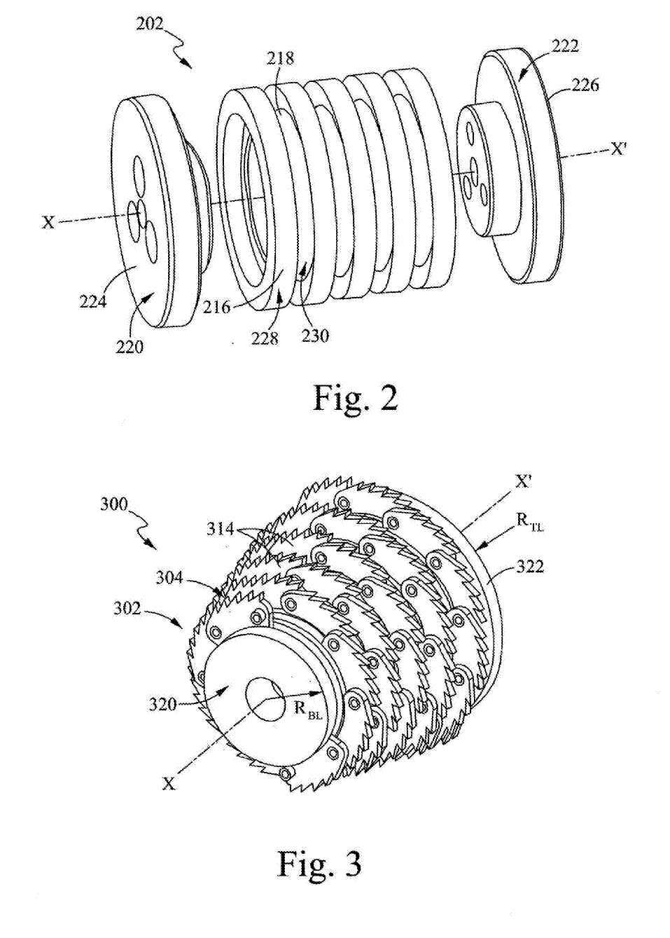

The tool body 102 comprises a generally axi-symmetric envelope 106 extending about the longitudinal axis X-X′. The envelope 106 is disposed between generally radially-extending coaxially-aligned first and second ends 108, 110 (better seen on FIG. 2, hidden on FIG. 1) of the tool body 102. The tool body 102 further comprises a plurality of channels 112 circumferentially defined on the envelope 106.

The chain 104 comprises a plurality of chain members 114 consecutively linked therebetween. The chain members 114 are disposed on the plurality of channels 112 such that the chain members 114 are configured to be placed one following, or partially overlapping, each other, circumferentially, while advancing axially, i.e., to spiral circumferentially about the tool body 102, but not necessarily by equal increments, from the first end 108 to the second end 110.

The envelope of the tool body 102 describes a surface of revolution and any desirable profile may be used as its outline. In the exemplary embodiment of the tool body 102 as shown in FIG. 1, the plurality of channels 112 defined on the envelope 106 may comprise a plurality of ridge faces 116, and a plurality of groove faces 118. The ridge faces 116 and the groove faces 118 are arranged such that the ridge faces 116 and the groove faces 118 are parallel and alternately disposed with each other. Generally, a local ridge diameter R_{DL} of a particular ridge face 116 is larger than a local groove diameter D_{GL} of any groove face 118 adjacent to the particular ridge face 116.

The tool body 102 may be solid and/or hollow, as desired. Moreover, the tool body 102 may be monolithic (as shown in FIG. 1) and/or modular, as desired. FIG. 2 schematically illustrates a modular tool body 202. Since the modified embodiment of the tool body 202 is generally reminiscent of the exemplary embodiment of the tool body 102, components which are similar between the modified embodiment modular tool body 202 and the exemplary embodiment tool body 102 will be annotated by similar numbers increased by 100.

The modular tool body 202 comprises a bottom lid 220 and a top lid 222 distally located from each other along the longitudinal axis X-X′. The bottom lid 220 and the top lid 222 may serve as an outer face 224 and an inner face 226 of the modular tool body 202 respectively.

The modular tool body 202 may include alternating and interfitting ridge rings 228 and groove rings 230 disposed between the top lid 222 and the bottom lid 220. The ridge rings 228 and the groove rings 230 may axially extend between the bottom lid 220 and the top lid 222 along the longitudinal axis X-X′ of the tool body 202 to terminate at the top lid 222 of the tool body 202. Each of the ridge rings 228 may define a ridge face 216 thereon while each of the groove rings 230 may define a groove face 218 thereon.

FIG. 3 schematically illustrates a schematic modified embodiment of a chain tool 300. Since the modified embodiment of the tool body 302 is generally reminiscent of the exemplary embodiment of the chain tool 100, components which are similar between the modified embodiment chain tool 300 and the exemplary embodiment chain tool 100 will be annotated by similar numbers increased by 200.

The chain tool 300 has a tool body 302 having a generally frustoconical shape, with a bottom lid 320 (seen on the bottom left of FIG. 3) having a smaller bottom lid diameter R_{BL} than a top lid diameter R_{TL} of a top lid 322 of the tool body 302. Two parallel chains 304 are wrapped about the frustoconical tool body 302, starting adjacent the bottom lid 320 and spiraling away and circumferentially around the tool body 302 to terminate adjacent the top lid 322. Each chain 304 comprises a plurality of chain members 314 consecutively linked therebetween to form the chain 304.

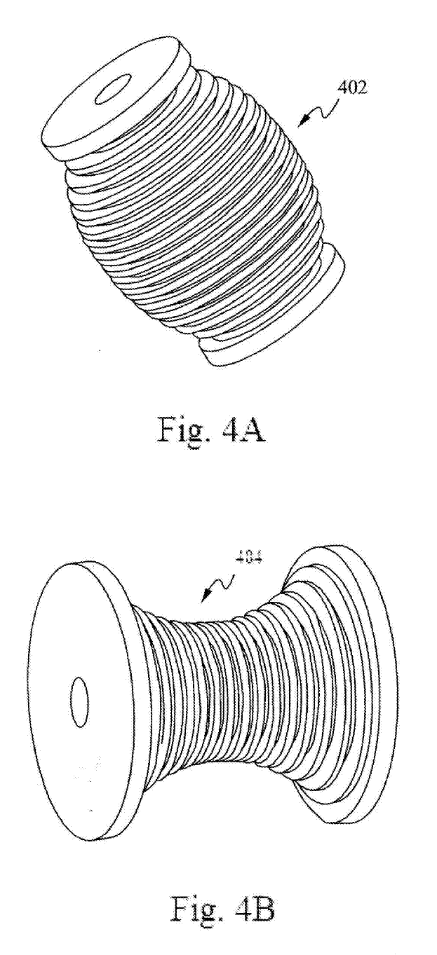

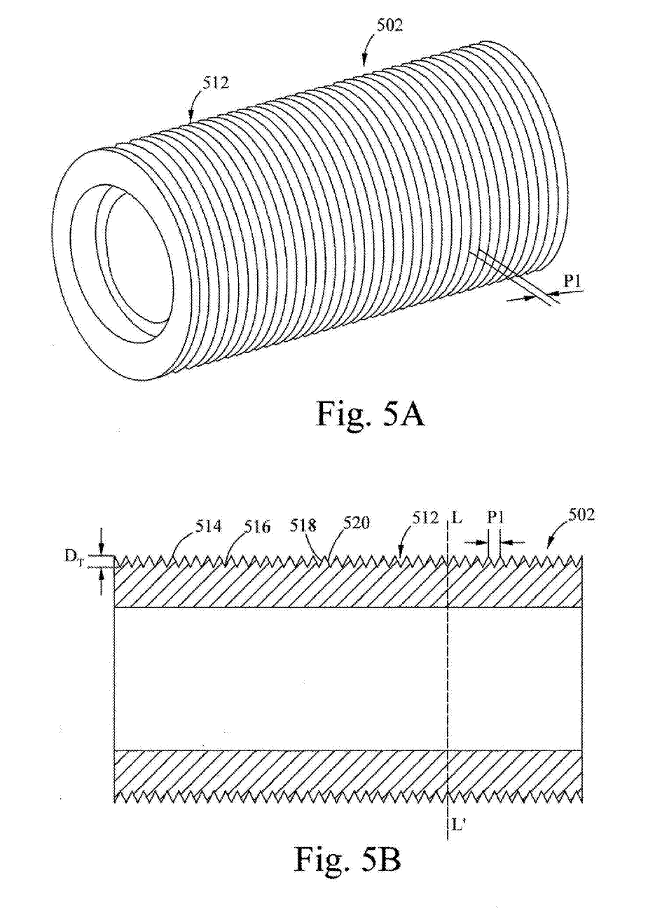

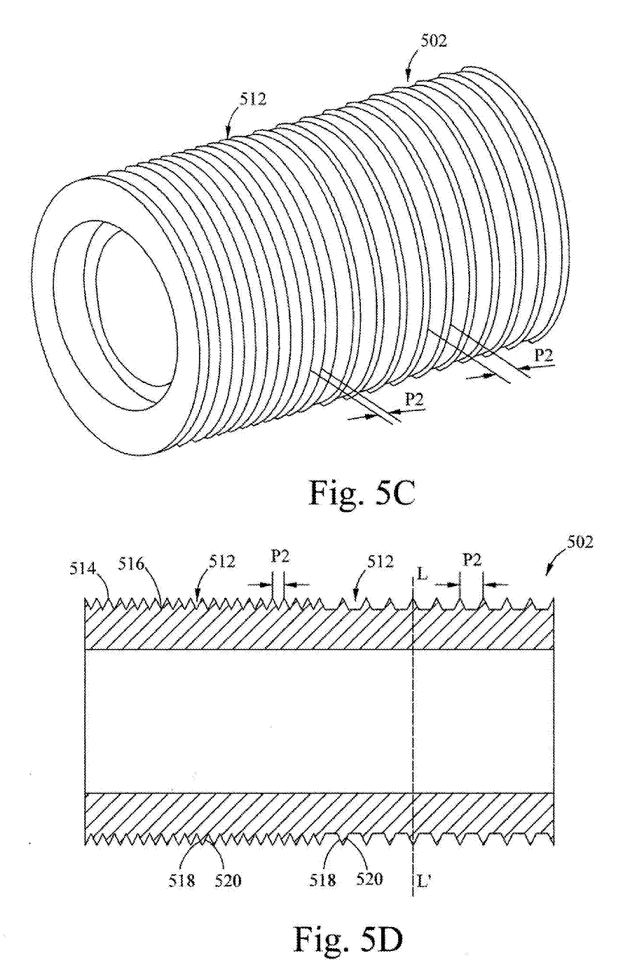

Referring to FIGS. 4A and 4B, exemplary embodiments of tool bodies 402, 404 are illustrated. The tool body 402 of FIG. 4A illustrates a convex shape thereof while the tool body 404 of FIG. 4B illustrates a concave shape thereof. Although the convex and concave shapes are rendered to the tool bodies 402, 404 of FIGS. 4A and 5B respectively, it is to be noted that these shapes are merely exemplary in nature and hence, non-limiting of this disclosure. Any profile may be used to form and shape the tool bodies 402, 404 depending on specific requirements of various applications. Further, complex profiles such as but not limited to, curvilinear profiles and other, not always easily defined profiles may also be imparted to give form and shape to the tool bodies 402, 404.

Referring to FIGS. 5A and 5B, an alternative embodiment of the tool body 502 is illustrated. The channels 512 of the tool body 502 include alternating peaks 514 and troughs 516 linked by sloping sidewalls 518, 520 such that the alternating peaks and troughs 518, 520 are configured to define a generally triangular, generally trapezoidal, and/or generally sinusoidal, i.e., a sloped profile in a circumferential cross-section of the tool body 502, as best seen in FIG. 5B. A local peak diameter D_{P} of a particular peak 514 is greater than a trough diameter D_{T} of any adjacent trough 516.

Further, the channels 512 include a pitch P1 defined therebetween. The pitch P1 may be measured from one peak 514 to a successive or preceding peak 514. Alternatively, the pitch P1 may be measured as the distance from one trough 516 to a successive or preceding trough 516. In the embodiments of FIGS. 5A and 5B, the pitch P1 defined between adjacent channels 512 is equal i.e., the pitch P1 may be uniform across a length of the tool body 502. However, in an alternative embodiment of the tool body 504 as illustrated in FIG. 5C, a pitch P2 between adjacent channels 512 of the tool body 504 is unequal i.e., the pitch P2 between channels 512 across various sections of the tool body 504 may be non-uniform. Explanation to the equal and unequal pitches P1, P2 of the tool bodies 502, 504 may become clearer upon perusal of the disclosure hereinafter.

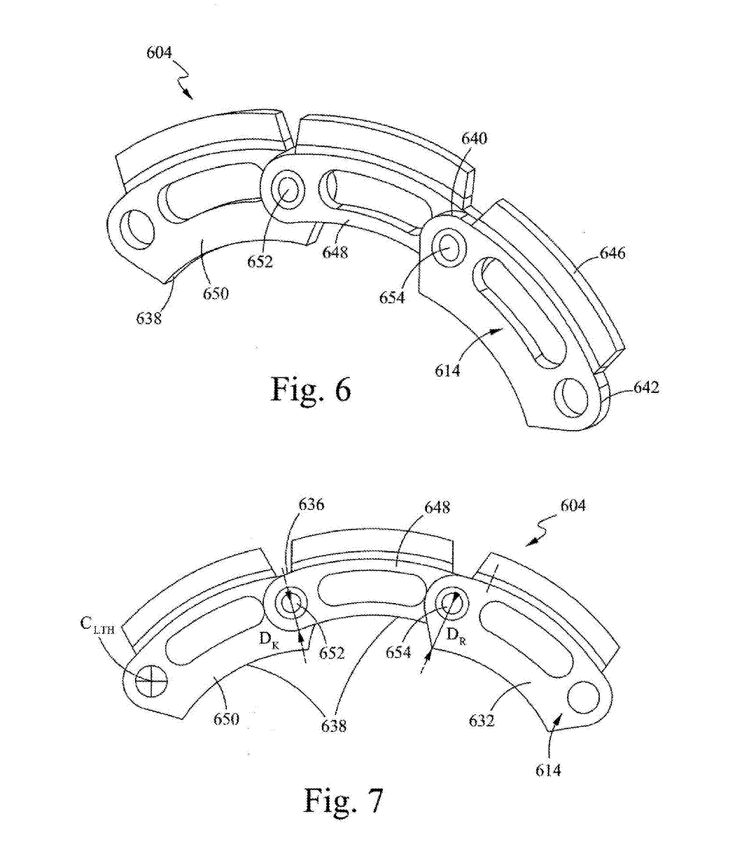

FIGS. 6, 7 and 8 show a schematic general representation of an exemplary first embodiment of a chain 604, and a first embodiment of a chain member 614 respectively. Since the first embodiment of the chain 604 is generally reminiscent of the chain 104, components which are similar between the first embodiment chain 604 and the chain 104 will be annotated by similar numbers increased by 500.

Further, since the particular embodiment of the chain member 614 is generally reminiscent of the exemplary embodiment of the chain member 114, components which are similar between the modified embodiment chain member 614 and the exemplary embodiment chain member 114 will be annotated by similar numbers increased by 500.

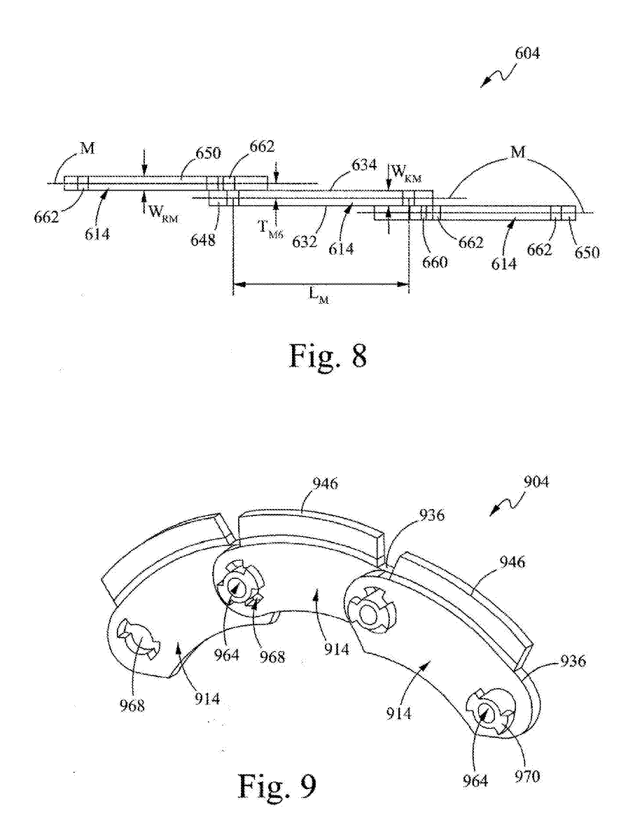

As best shown in FIG. 8, the first embodiment chain 604 comprises a plurality of first embodiment chain members 614. As best shown in FIG. 8, each of the first embodiment chain members 614 comprises a first sidewall 632 and a second sidewall 634 disposed in an opposing and substantially parallel relation to each other. The first and second sidewalls 632, 634 may be separated by a member thickness T_{M6}.

Referring to FIG. 7, each of the first embodiment chain member 614 further comprises an outer side 636 and an inner side 638 laterally disposed to the first and second sidewalls 632, 634. The outer side 636 and the inner side 638 may extend into each other to further define a pair of peripheral sides 640, 642. Furthermore, the outer side 636 is provided with a first embodiment appendage 646 upstanding therefrom. The first embodiment appendage 646 is adapted for machining and removing chips from a material (not shown).

As shown in FIGS. 6 and 7, the first embodiment chain members 614 may comprise at least one keel member 648, and at least one rider member 650 linked to the keel member 648. The keel members 648 (only one keel member shown in FIGS. 6 and 7) and the rider members 650 may alternate with each other.

Turning back to FIG. 1, the chain members 114 are wrapped about the envelope 106, wherein the inner side 638 of the chain members 114 is configured to abut with the envelope 106. In particular, the rider members 650 of the chain 604 are supported on the ridge faces 116 of the tool body 102, while the keel members 648 of the chain are supported on the groove faces 118 of the tool body 102.

Turning to FIG. 8 and in reference with FIG. 1, a width W_{KM} of the keel member 648 and a width W_{RM} of the rider member 650 correspond to a width W_{R} of the ridge face 116 and a width W_{G} of the groove face 118 on the tool body 102, respectively.

Although the present disclosure discloses that the rider members 650 of the chain 604 are supported on the ridge faces 116 of the tool body 102, while the keel members 648 of the chain 104 are supported on the groove faces 118 of the tool body 102, alternatively, it may be possible to support the rider members 650 on the groove faces 118, and the keel members 648 on the ridge faces 116 of the tool body 102.

As shown in FIGS. 6 and 7, the sixth embodiment chain members 614 comprises a pair of connectors 652, 654 disposed between the outer and inner sides 636, 638 of each of the chain members 614. The first connector 652 may be disposed adjacent to the first sidewall 632 while the second connector 654 may be disposed adjacent to the second sidewall 634 of each chain member 614.

Further, a portion of each keel member 648 is submerged below the ridge faces 116 and supported between adjacent ridge faces 116 on the envelope 106 as shown in FIG. 1. Referring to FIG. 7, a depth D_{K} of the keel members 648 measured from a center of the connector 652 to a basal face 656 of the keel members 648 is less than a depth D_{R} of the rider members 650 measured from the center of the connector 654 to a basal face 658 of the rider members 650.

Referring to FIG. 8, the two connectors 652, 654 of a single chain member 614 define therebetween a member length L_{M}. In the sixth embodiment chain members 614, a pin 660 is inserted through two matching and co-aligned pin through-holes or bores 662 defined in two serially aligned chain members 614, wherein each pin through-holes or bores 662 is defined in one of the two neighboring chain members 614.

Referring to FIG. 9, a second embodiment of the chain 904 is illustrated. The second embodiment chain 904 comprises a plurality of second embodiment chain members 914. Any two subsequent second embodiment chain members 914 are swivelly connected therebetween by a lug 964. In the second embodiment chain 904, the lug 964 is integral with one of the second embodiment chain member 914 and is insertable through a corresponding mount 968 of a preceding and/or subsequent second embodiment chain member 914. The lug 964 has at least one radial projection 970 extending away from the lug 964 and the mount 968 is shaped as to allow the at least one radial projection 970 to pass therethrough when the lug 964 is in a certain position while preventing such passage in any other position, so that the mount 968 facilitates insertion of the lug 964 when the chain members 914 are in an insertion range of positions relative to one another, and prevents insertion and/or extraction when the chain members 914 are in a securing range of positions relative to each other, as is known in the art.

At least some of the plurality of second embodiment chain members 914 may be provided with an appendage 946 on and/or about an outer side 936 thereof that may accommodate functional means for performing desired functions, as is well known in the art.

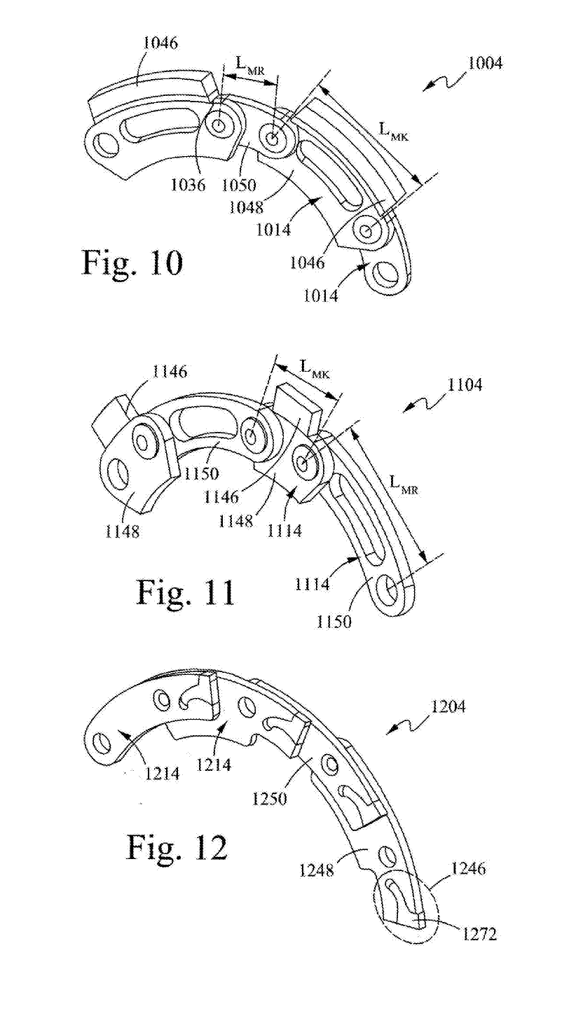

Attention is presently drawn to FIG. 10, showing a schematic illustration of a third embodiment of a chain 1004. Since the third embodiment of the chain 1004 is generally reminiscent of the first embodiment of the chain 604, components which are similar between the third embodiment chain 1004 and the first embodiment chain 604 will be annotated by similar numbers increased by 400.

The third embodiment chain 1004 comprises a plurality of third embodiment chain members 1014. In the third embodiment of the chain 1004, there is at least one keel member 1048 and at least one rider member 1050. In the third embodiment chain 1004, a keel member length L_{MK} of the keel member 1048 is greater than a rider member length L_{MR} of the rider member 1050. Moreover, in the third embodiment of the chain 1004 only keel members 1048 are shown to be provided with an appendage 1046 on and/or about an outer side 1036 thereof that may accommodate functional means for performing desired functions. However, rider members 1050 may alternatively and/or additionally be provided with appropriate appendages (not shown).

Attention is presently drawn to FIG. 11, showing a schematic illustration of a fourth embodiment of a chain 1104. Since the fourth embodiment of the chain 1104 is generally reminiscent of the first embodiment of the chain 604, components which are similar between the fourth embodiment chain 1104 and the first embodiment chain 604 will be annotated by similar numbers increased by 500. The fourth embodiment chain 1104 comprises a plurality of fourth embodiment chain members 1114. In the fourth embodiment of the chain 1104, there is at least one keel member 1148 and at least one rider member 1150. In the fourth embodiment chain 1104, a keel member length L_{LK} of the keel member 1148 is smaller than a rider member length L_{LR} of the rider member 1150. Moreover, in the fourth embodiment of the chain 1104 only keel members 1148 are shown to be provided with an appendage 1146 on and/or about an outer side 1136 thereof that may accommodate functional means for performing desired functions. However, rider members 1150 may alternatively and/or additionally be provided with appropriate appendages (not shown).

With reference to the third embodiment chain members 1014 and the fourth embodiment chain members 1114 as shown in FIGS. 10 and 11 respectively, and with continued reference to the alternative embodiment of the tool body 504 of FIGS. 5C and 5D, it is hereby envisioned that various lengths L_{MK}, L_{MR}, L_{LK}, and L_{LR} of the respective chain members 1014/1114 are configured to correspond with the varying pitches P1, P2 of the tool bodies 502/504 of FIGS. 5A-5B and FIGS. 5C-5D. Therefore, it may be contemplated by one having ordinary skill in the art to configure chain members 1014/1114 with identical or different lengths such that the chain members 1014/1114 correspond with the uniform pitch P1 or the varying pitch P2 present between the channels 512 of the tool bodies 502/504 of FIGS. 5A-5B and FIGS. 5C-5D.

Attention is presently drawn to FIG. 12, showing a schematic illustration of a fifth embodiment of a chain 1204. Since the fifth embodiment of the chain 1204 is generally similar to the first embodiment of the chain 604, components which are similar between the fifth embodiment chain 1204 and the first embodiment chain 604 will be annotated by similar numbers increased by 600. The fifth embodiment chain 1204 comprises a plurality of fifth embodiment chain members 1214. In the fifth embodiment of the chain 1204, there is at least one keel member 1248 and at least one rider member 1250. In the fifth embodiment of the chain 1204, the keel members 1248 as well as the rider members 1250 are shown to be provided with an appendage 1246 on or about an outer side (not shown) and/or a first and/or a second sidewall thereof that may accommodate functional means for performing desired functions, such as a cutting insert 1272. However, keel members 1248 and/or rider members 1250 may alternatively be provided with appropriate appendages (not shown). In the fifth embodiment of the chain 1204, the appendage 1246 may accommodate the cutting insert 1272 within a pocket, as is well known in the art.

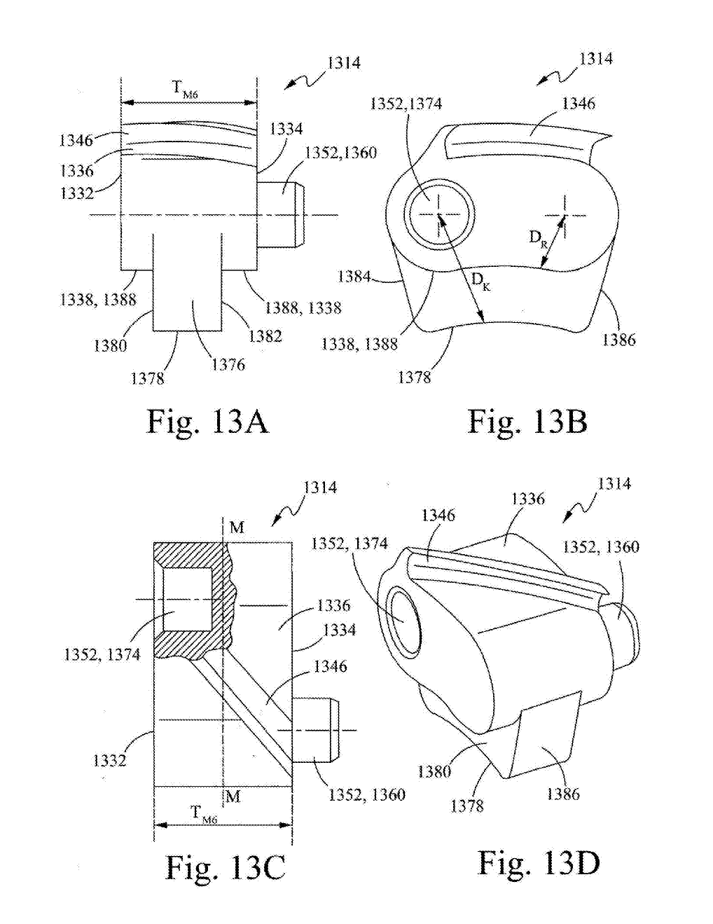

FIGS. 13, 14 and 15 show a schematic general representation of an exemplary sixth embodiment of a chain member 1314, a sixth embodiment of a chain 1304, and a particular embodiment of a chain tool 1300, respectively. Since the sixth embodiment of the chain 1304 as well as the sixth embodiment chain member 1314 are generally similar to the first embodiment of the chain 604 and the first embodiment of the chain member 614, components which are similar between the sixth embodiment chain 1304 and the first embodiment chain 604 will be annotated by similar numbers increased by 700. Similarly, since the particular embodiment of the chain tool 1300 is generally similar to the exemplary embodiment of the chain tool 100, components which are similar between the modified embodiment chain tool 1300 and the exemplary embodiment chain tool 100 will be annotated by similar numbers increased by 1200.

The sixth embodiment chain 1304 comprises a plurality of sixth embodiment chain members 1314. Each one of the plurality of sixth embodiment chain members 1314 comprises two generally parallel and opposing first and second sidewalls 1332, 1334 separated by a member thickness T_{M6}. Each of the sixth embodiment chain member 1314 further comprises an outer side 1336 and an inner side 1338 laterally disposed to the first and second sidewalls 1332, 1334. The outer side 1336 and the inner side 1338 may extend into each other to further define a pair of peripheral sides 1340, 1342.

Any two subsequent sixth embodiment chain members 1314 are pivotally connected together by means of a connector 1352. In the sixth embodiment chain 1304, the connector 1352 is in a shape of a pin and a socket. On the first sidewall 1332 adjacent to the second sidewall 1334 and generally between the inner and outer sides 1338, 1336, there is disposed a socket 1374 while from the opposite second sidewall 1334, adjacent to the first sidewall 1332 and generally between the inner and outer sides 1338, 1336, there is disposed a pin 1360. The pin 1360 protrudes away from the second sidewall 1334 generally transversely thereto, while the socket 1374 is sunk into the chain member 1314 inside of the first sidewall 1332 and generally transversely thereto.

The outer side 1336 is provided with a sixth embodiment appendage 1346 upstanding therefrom. The sixth embodiment appendage 1346 is adapted to chip removing machinery. The inner side 1338 has a keel 1376 disposed thereon, merging with the inner side 1338 and jutting outwardly away therefrom so as to terminate at a keel face 1378. The keel 1376 has generally parallel and opposed first and second keel flanks 1380, 1382 merging with, and upstanding from, the inner side 1338 and interconnected by the keel face 1378 and generally opposed first and second keel walls 1384, 1386 extending therebetween generally transversely to the first and second keel flanks 1380, 1382. The keel 1376 is disposed generally about the center of the sixth embodiment chain member 1314 wherein the width T_{M6} is defined as the distance between the first and second sidewalls 1332, 1334, and has a keel thickness T_{K} defined as the distance between the first and the second keel flanks 1380, 1382. The keel 1376 is flanked by generally similar rider faces 1388 of the inner side 1338. As best seen in FIG. 13C, each one of the plurality of chain members 1314 comprises a median plane M passing between the generally parallel and opposing first and second sidewalls 1332, 1334 and bisecting the sixth embodiment member thickness T_{M6}.

In the sixth embodiment of the chain 1304, each sixth embodiment chain member 1314 has a rider depth D_{R} defined as a distance from the center of the connector 1352 to the rider face 1388 of the sixth embodiment chain member 1314 and a keel depth D_{K} defined as the distance from the center of the connector 1352 to the keel face 1378. In the sixth embodiment of the chain 1304, the keel depth D_{K} is greater than the rider depth D_{R}.

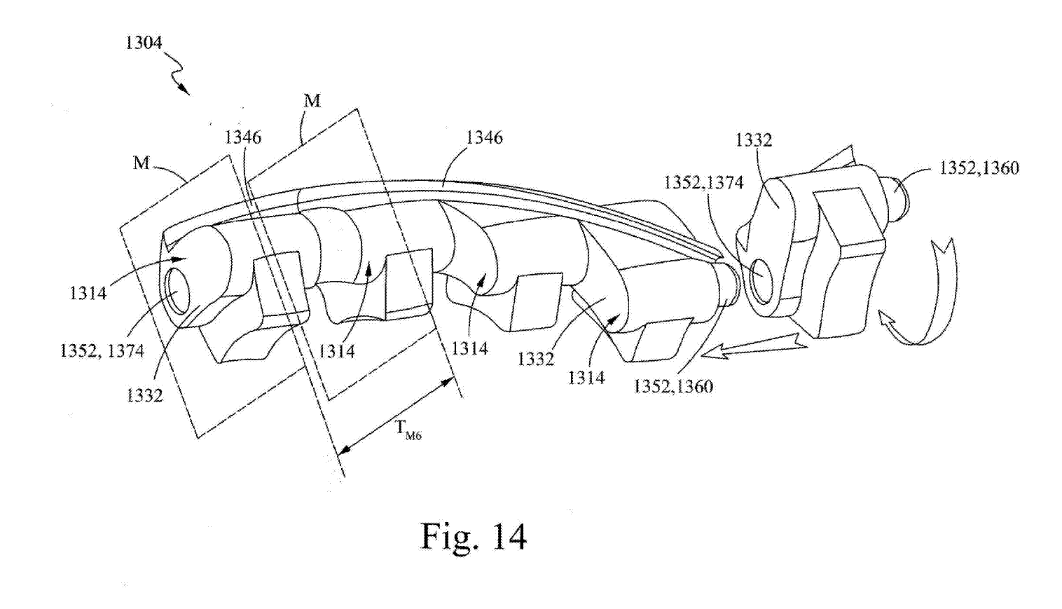

Attention is presently directed to FIG. 14. Sixth embodiment chain members 1314 are arrayed as a sixth embodiment chain 1304 by moving the first sidewall 1332 of a subsequent chain member 1314 towards the second sidewall 1334 (hidden in FIG. 14) of a preceding chain member 1314. The connector 1352 then connects the preceding and the subsequent chain members 1314 together, as is well known in the art. As the sixth embodiment chain members 1314 are chained together so as to form the sixth embodiment chain 1304, median planes M of subsequent sixth embodiment chain members 1314 are disposed parallel relative to each other. In the sixth embodiment of the chain 1304, adjacent median planes M are disposed parallel to each other displaced by a distance corresponding to the member thickness T_{M6}.

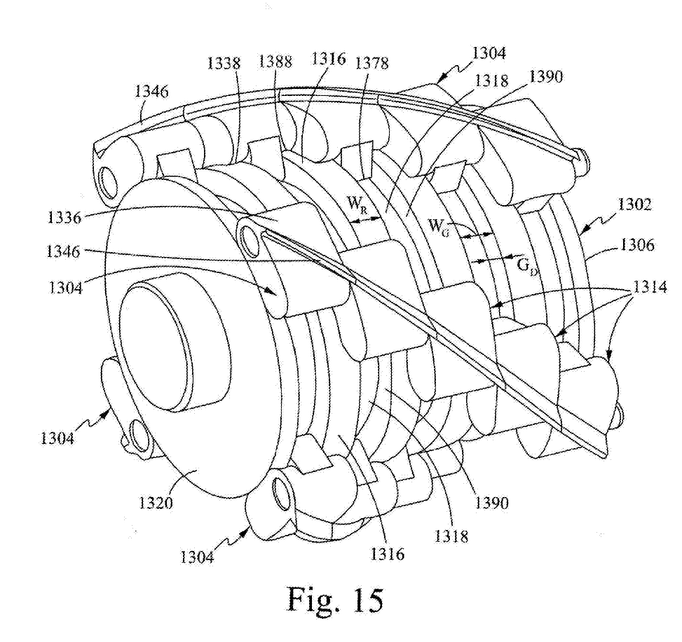

Referring now to FIG. 15, there is shown a particular embodiment of a chain tool 1300 having a plurality of sixth embodiment chains 1304 wrapped therearound. The chain tool 1300 has a tool body 1302 having a generally cylindrical shape, with a bottom lid 1320 (seen on the bottom left of FIG. 15) and an opposing top lid (not shown) of the tool body 1302. Four generally parallel chains 1304 are wrapped around the tool body 1302, starting adjacent the bottom lid 1320 and spiraling away and circumferentially around the tool body 1302 so as to terminate adjacent the top lid (not shown). Each chain 1304 comprises a plurality of chain members 1314 consecutively attached so as to form the chain 1304.

The tool body 1302 comprises an envelope 1306 extending generally axially away from the bottom lid 1320 so as to terminate at the top lid (hidden in FIG. 15). The envelope 1306 describes a surface of revolution and any desirable curve may be used as its outline. The envelope 1306 of the tool body 1302 comprises parallel and alternating ridge faces 1316 and groove faces 1318 extending circumferentially around the envelope 1306. Each one of the groove faces 1318 extends between a first fence (hidden in FIG. 15) and a generally parallel and opposing second fence 1390, while a consecutive groove face 1318 extends between the second fence 1390 and a consecutive first fence (not shown).

Each one of the plurality of sixth embodiment chain members 1314 has its inner side 1338 touching the envelope 1306. The inner side 1338 of each chain member 1314 rides one of the ridge faces 1316 of the tool body 1302, with each one of the rider faces 1388 of each one of the inner sides 1338 touching consecutive ridge faces 1316, while each keel face 1378 is facing, but not necessarily abutting, the groove face 1318. A portion of each keel member 1348 is submerged below one of the ridge faces 1316 and is supported by the first fence (not shown) and the second fence 1390 of the envelope 1306. A ridge width W_{R} and a groove width W_{G} are generally similar to the member thickness T_{M6}, while the groove depth G_{D} of each groove face 1318, extending radially inwardly below the ridge face 1316, is generally the difference between the keel depth D_{K} and the rider depth D_{R}.

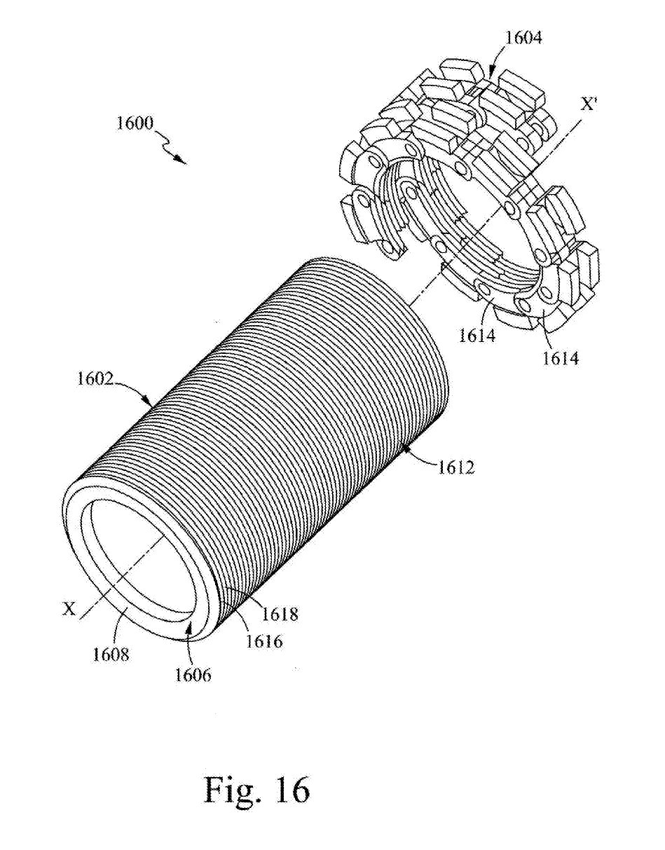

FIG. 16 shows a schematic general perspective representation of an alternative exemplary embodiment of a chain tool 1600 comprising an alternative tool body 1602 accommodating a plurality of a schematic, representative embodiment chain members 1614. Since the alternative embodiment of the chain 1604 as well as the alternative embodiment chain member 1614 are generally similar to the first embodiment of the chain 604 and the first embodiment of the chain member 614, components which are similar between the alternative embodiment chain 1604 and the first embodiment chain 604 will be annotated by similar numbers increased by 1000. Similarly, since the particular embodiment of the chain tool 1600 is generally similar to the exemplary embodiment of the chain tool 100, components which are similar between the modified particular embodiment chain tool 1600 and the exemplary embodiment chain tool 100 will be annotated by similar numbers increased by 1500.

The tool body 1602 comprises a generally axi-symmetric envelope 1606 extending about the longitudinal axis X-X′. The tool body 1602 further comprises a plurality of channels 1612 circumferentially defined on the envelope 1606. The envelope of the tool body 1602 describes a surface of revolution and any desirable profile may be used as its outline. In the exemplary embodiment of the tool body 1602 as shown in FIG. 1, the plurality of channels 1612 defined on the envelope 1606 may comprise a plurality of ridge faces 1616, and a plurality of groove faces 1618. The ridge faces 1616 and the groove faces 1618 are arranged such that the ridge faces 1616 and the groove faces 1618 are parallel and alternately disposed with each other.

The chain 1604 comprises a plurality of chain members 1614 consecutively linked therebetween. The chain members 1614 are disposed on the plurality of channels 1612 such that the chain members 1614 are configured to spiral circumferentially about the tool body 1602 from the first end 1608 to a second end (hidden in FIG. 16).

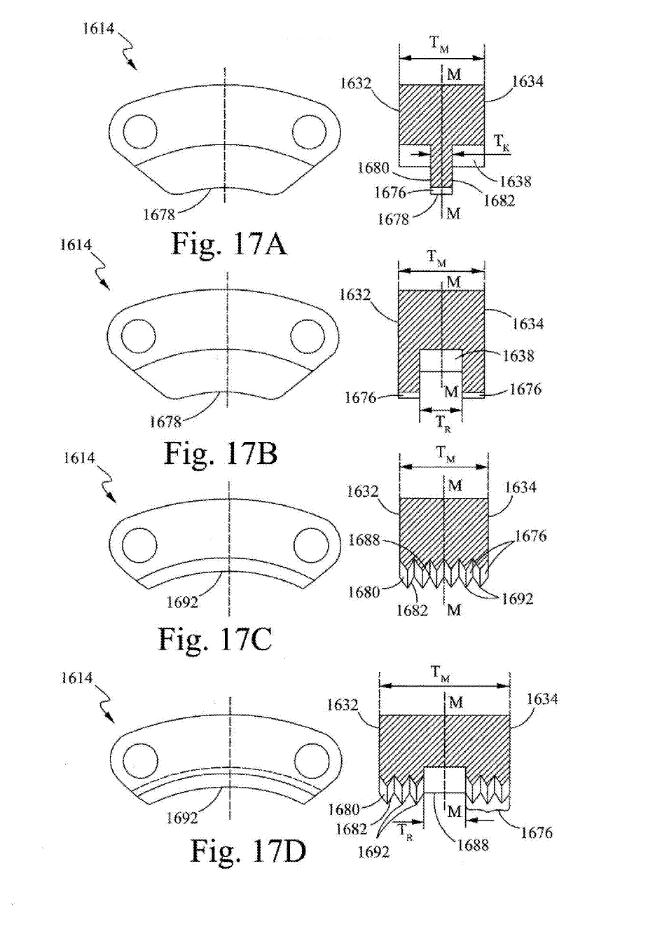

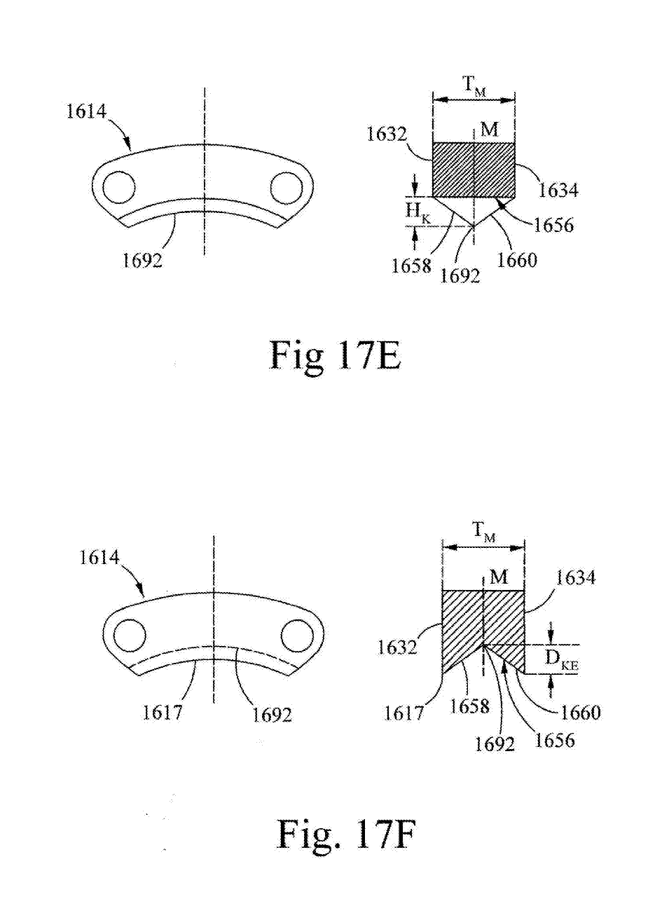

FIG. 17A to FIG. 17F show various forms and shapes conceivable of the seventh embodiment chain member 1614. Although some forms are illustrated herein, it is to be noted that these forms merely exemplary in nature and hence, non-limiting of this disclosure. A person having ordinary skill in the art may appreciate that various forms and configurations may be possible on the chain members 1614 for adaptation and use with the exemplary embodiment of the tool body 1602.

As best seen in FIGS. 17A to 17B, each of the chain members 1614 comprises a median plane M passing between the generally parallel and opposing first and second sidewalls 1632, 1634 and bisecting the sixth embodiment member thickness T_{M6}. The inner side 1638 has at least one keel 1676 disposed thereon, merging with the inner side 1638 and jutting outwardly away therefrom so as to terminate at a plurality of keel faces 1678. The keels 1676 have generally parallel and opposed first and second keel flanks 1680, 1682 merging with, and upstanding from, the inner side 1638 and interconnected by the keel faces 1678. Particularly referring to FIG. 17A, a single keel 1676 extends away from the inner side 1638 of the chain member 1614. The keel 1676 is disposed transversely about the median plane M such that the median plane bisects the keel thickness T_{K}. The keel 1676 is flanked by a pair of generally similar rider faces 1688 on the inner side 1638 of the chain member 1614. Particularly referring to FIG. 17B, two keels 1676 extend away from the inner side 1638 of the chain member 1614 with a single rider face 1688 defined therebetween on the inner side 1638 of the chain member 1614. Therefore, the rider face 1688 is disposed transversely about the median plane M such that the median plane bisects the rider thickness T_{R}.

As best seen in FIGS. 17C to 17D, the inner side 1638 of the chain member 1614 has a plurality of keels 1676 disposed thereon, merging with the inner side 1638 and jutting outwardly away therefrom so as to terminate at a plurality of keel edges 1692. The keels 1676 have generally inclined and opposed first and second keel flanks 1680, 1682 merging with, and upstanding from, the inner side 1638 and interconnected by the keel edges 1692. Particularly referring to FIG. 17C, the keels 1676 are flanked by generally similar rider faces 1688 on the inner side 1638 of the chain member 1614. Particularly referring to FIG. 17D, two sets of keels 1676 extend away from the inner side 1638 such that a rider face 1688 is defined therebetween. Therefore, the rider face 1688 is disposed transversely about the median plane M such that the median plane bisects the rider thickness T_{R}.

As best seen in FIGS. 17E and 17F, each of the chain members 1614 includes a basal face 1656. The basal face 1656 includes a first slant face 1658, and a second slant face 1660 disposed in opposing relation to the first slant face such that the first and second slant faces 1658, 1660 are configured to rest upon the sloping sidewalls 518, 520 of the tool body 502/504, as shown in FIG. 5B.

Each of the chain members 1614 further includes a keel edge 1692 defined at an intersection of the first and second slant faces 1658, 1660. The keel edge 1692 is configured to rest upon one of a peak 514 and a trough 516 of the tool body 502/504. More specifically, the keel edge 1692 of FIG. 17E is configured to rest upon the trough 516 of the tool body 502/504 while the slant faces 1658, 1660 abut the sloping sidewalls 518, 520 lying adjacent to the trough 516. Referring to FIG. 17F and FIG. 5B, it can be seen that a height H_{K} of the keel edge 1692 from the basal face 1656 may correspond to a difference in depth D_{T} of the trough 516 from the peak 514 measured along linear axis L-L′.

Similarly, with regards to the chain member 1614 of FIG. 17D, the keel edge 1692 may be configured to rest upon the peak 516 of the tool body 502/504 while the slant faces 1658, 1660 abut the sloping sidewalls 518, 520 lying adjacent to the peak 514. Referring to FIG. 17F and FIG. 5B, it can be seen that a depth D_{KE} of the keel edge 1692 from an outer end 1617 of the basal face 1656 may correspond to a difference in height H_{P} of the peak 514 from the trough 516 measured along linear axis L-L′.

Therefore, with reference to the embodiments shown in FIGS. 5A-5B, and FIGS. 17E-17F, it is evident that the generally triangular, generally trapezoidal, and/or generally sinusoidal, i.e., a sloped cross-section defined by the peaks 514 and troughs 516 on the circumference of the tool body 502, 504, may thus, confirm with a shape of the basal face 1656 as defined by the first and second slant faces 1658, 1660 of the chain member 1614. Although the tool bodies 502/504 with the generally triangular, generally trapezoidal, and/or generally sinusoidal, i.e., a sloped cross-section is disclosed for adaptation with the slant faces 1658, 1660 of the chain members 1614, it may be noted that the profile of the tool bodies 502/504 and the profile on the basal face 1656 of the chain members 1614 are non-limiting of this disclosure. A person having ordinary skill in the art may contemplate various forms and shapes known in the art to impart the required profiles to the tool bodies 502/504 and/or the chain members 1614.

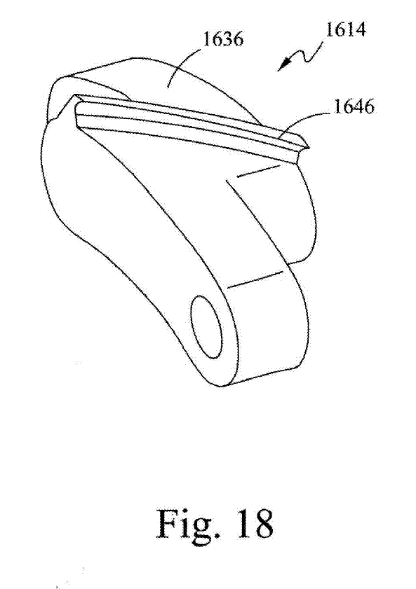

FIG. 18 shows a schematic top perspective view of an exemplary seventh embodiment chain member 1614 adapted to be accommodated on the alternative embodiment of the chain tool 1600 shown on FIG. 16. The outer side 1636 of at least some chain members 1614 is provided with a seventh embodiment appendage 1646 upstanding therefrom. The seventh embodiment appendage 1646 is adapted for machining and removing chips from a material (not shown).

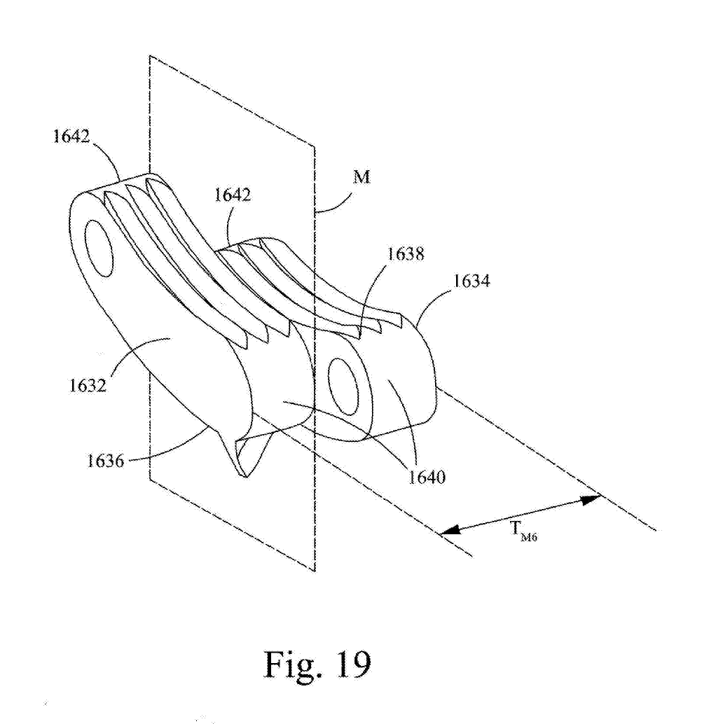

FIGS. 19, 20 and 21 show a schematic general representation of the alternative seventh embodiment chain member 1614. Since the alternative seventh embodiment chain member 1614 is generally similar to the first embodiment of the chain member 614, components which are similar between the seventh embodiment chain member 1614 and the first embodiment chain member 614 will be annotated by similar numbers increased by 1000.

As best shown in FIG. 19, each one of the plurality of seventh embodiment chain members 1614 comprises two generally parallel and opposing first and second sidewalls 1632, 1634 separated by a member thickness T_{M6}. Each of the sixth embodiment chain member 1614 further comprises an outer side 1636 and an inner side 1638 laterally disposed to the first and second sidewalls 1632, 1634. The outer side 1636 and the inner side 1638 may extend into each other to further define a pair of peripheral sides 1640, 1642. Further, as shown in FIGS. 19 to 21 the first sidewall and the second sidewall 1632, 1634 of the seventh embodiment chain members 1614 are offset along the median plane M such that the peripheral sides 1640, 1642 exhibit a tiered configuration.

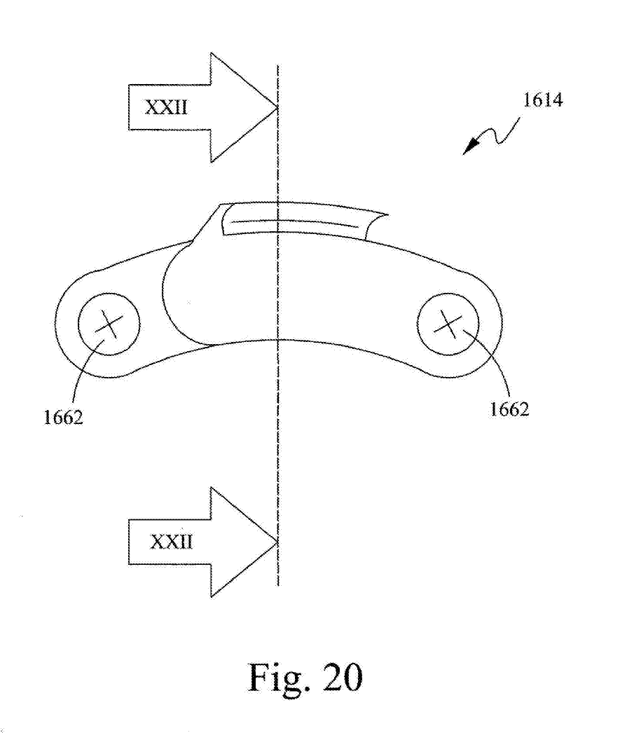

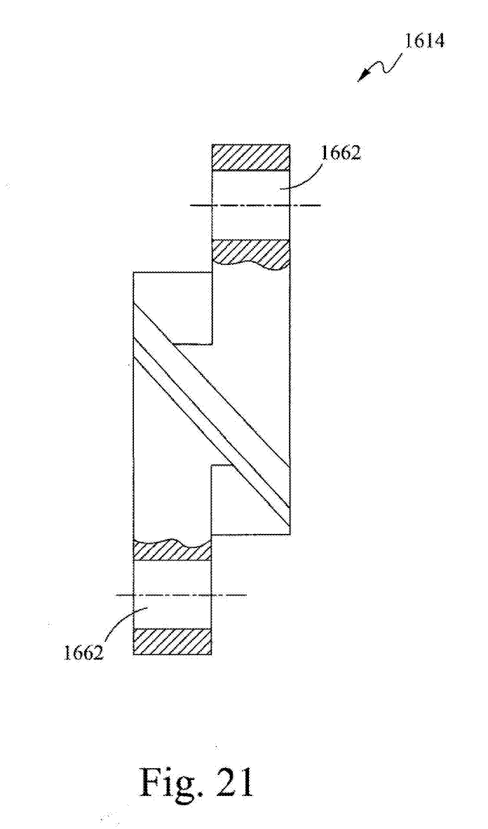

As best shown in FIG. 20 and FIG. 21, any two subsequent seventh embodiment chain members 1614 may be pivotally connected together by means of a connector (not shown). A pin (not shown) may be inserted through two matching and co-aligned pin through-holes or bores 1662 defined in two serially aligned chain members 1614, wherein each pin through-hole or bore 1662 is defined in one of the two neighboring chain members 1614.

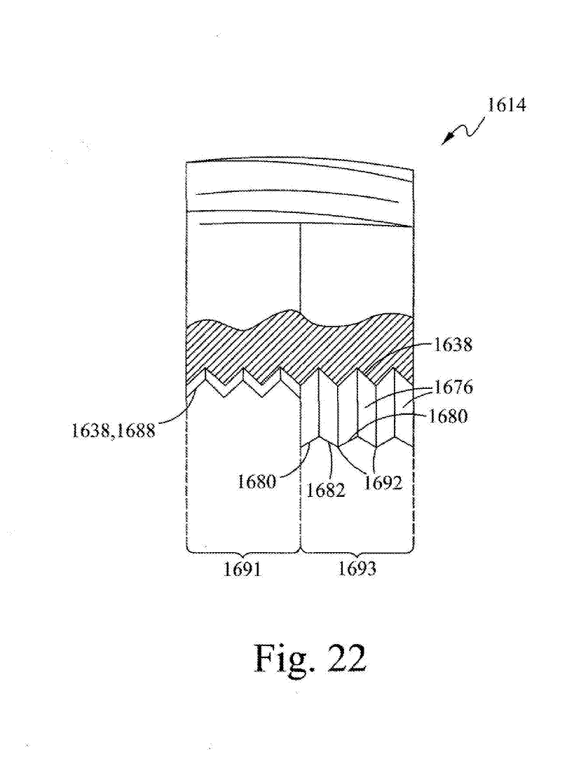

FIG. 22 shows a schematic axial section view of the exemplary seventh embodiment chain member 1614 shown on FIG. 18 taken along lines XXII-XXII in FIG. 20. The inner side 1638 of the chain member 1614 has a plurality of keels 1676 disposed thereon, merging with the inner side 1638 and jutting outwardly away therefrom so as to terminate at a plurality of keel edges 1692. The keels 1676 have generally inclined and opposed first and second keel flanks 1680, 1682 merging with, and upstanding from, the inner side 1638 and interconnected by the keel edges 1692. Further, the inner side 1638 of the chain member 1614 has a plurality of rider faces 1688 disposed thereon. The keels 1676 are disposed on one portion 1691 of the inner side 1638 while the rider faces 1688 are disposed on another portion 1693 of the inner side 1638.

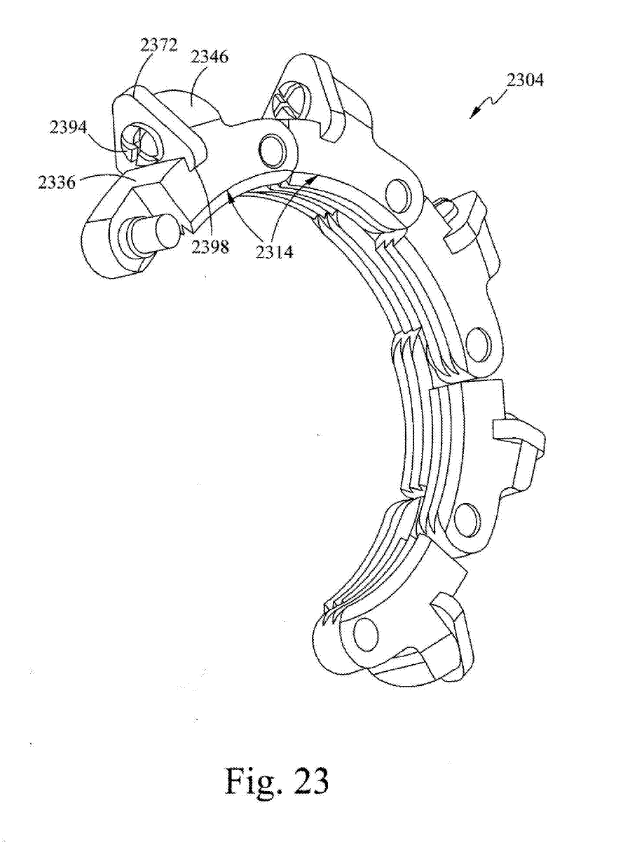

FIG. 23 shows a schematic perspective view of an exemplary eighth embodiment of a plurality of chain members 2314 adapted for engagement with the alternative exemplary tool body 1602 of FIG. 16. Since the alternative embodiment of the chain 2304 as well as the alternative embodiment chain member 2314 are generally similar to the first embodiment of the chain 604 and the first embodiment of the chain member 614 respectively, components which are similar between the alternative embodiment chain 2304 and the first embodiment chain 604 will be annotated by similar numbers increased by 1700.

The outer side 2336 of the eight embodiment chain members 2314 is provided with an eight embodiment appendage 2346 upstanding therefrom. The eighth embodiment appendage 2346 is adapted for machining and removing chips from a material (not shown), such as a cutting insert 2372. However, alternate eight embodiment chain members 2314 may be provided with appropriate appendages 2346. In the eighth embodiment of the chain 2304, the appendage 2346 may accommodate the cutting insert 2372 within a pocket 2398, as is well known in the art. Further, the cutting insert 2372 may be releasably attached to the appendage 2346 with the help of fasteners 2394 such as screws, bolts, or other fasteners commonly known in the art.

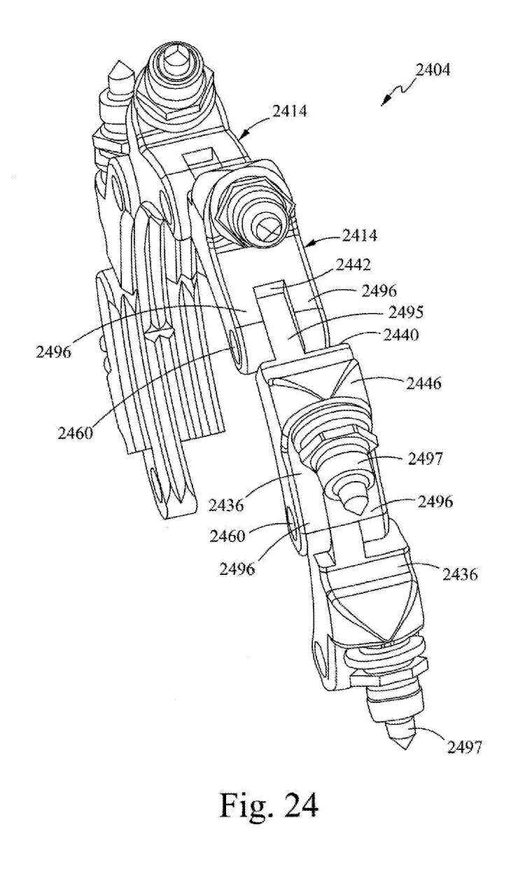

FIG. 24 shows a schematic perspective view of an exemplary ninth embodiment of a plurality of chain members 2414 adapted for engagement with the alternative exemplary tool body 1602 of FIG. 16. Since the alternative embodiment of the chain 2404 as well as the alternative embodiment chain member 2414 are generally similar to the first embodiment of the chain 604 and the first embodiment of the chain member 614 respectively, components which are similar between the alternative embodiment chain 2404 and the first embodiment chain 604 will be annotated by similar numbers increased by 1800.

Each of the ninth embodiment chain members 2414 may include at least one prong 2495 defined on a first periphery 2440 and at least one prong 2496 defined on a second periphery 2442. The prongs 2495 on the first periphery 2440 include matching and co-aligned pin through-holes or bores (hidden in FIG. 24) whereby a pin through-hole (not shown) on the prong 2496 may be aligned to accommodate a pin 2460 therethrough.

Further, the outer side 2436 of the ninth embodiment chain members 2414 is provided with an ninth embodiment appendage 2446 upstanding therefrom. The ninth embodiment appendage 2446 is adapted for milling and removing chips from a material (not shown), such as a milling tool 2497. However, the alternate ninth embodiment chain members 2414 may be provided with appropriate appendages 2446 to perform desired functions as commonly known in the art. In the ninth embodiment of the chain 2404, the appendage 2446 may include internal threads (hidden in FIG. 23) configured to threadedly engage with the milling tool 2497, as is well known in the art. However, the milling tool 2497 may be releasably attached to the appendage 2446 with the help of other fasteners commonly known in the art.

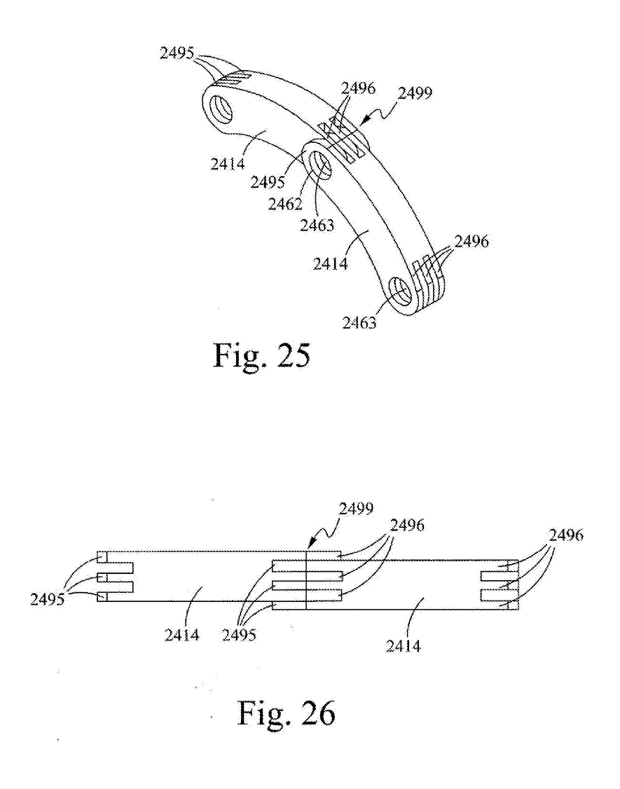

FIGS. 25 and 26 show a schematic representation of an exemplary link attachment means 2499. Each of the ninth embodiment chain members 2414 may include at least a pair of prongs 2495 defined on the first periphery 2440 and at least a pair of prongs 2496 defined on the second periphery 2442. The prongs 2495 on the first periphery 2440 and the prongs 2496 on the second periphery 2442 include matching and co-aligned pin through-holes or bores 2462, 2463 respectively (hidden in FIG. 25) whereby the pin through-holes 2462, 2463 on the prongs 2495, 2496 may be aligned to accommodate a pin (not shown) therethrough.

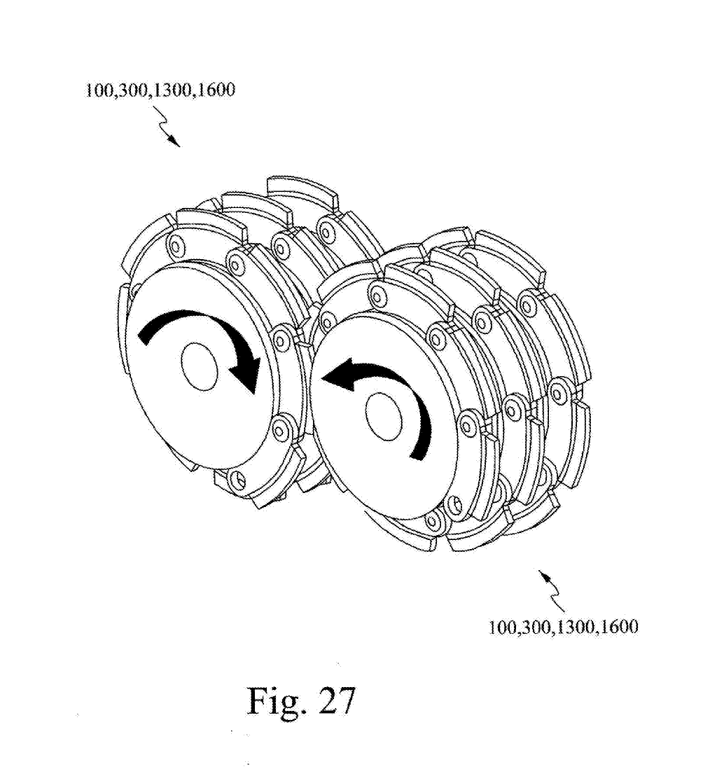

FIG. 27 shows a schematic of multiple tool bodies and multiple chain members of respective chain tools arranged to work in combination. Two or more exemplary embodiments of the chain tool 100, 300, 1300, or 1600 disclosed herein may be disposed adjacent to each other such that the longitudinal axes X-X′ of both chain tools 100, 300, 1300, or 1600 are disposed in parallel relation to each other. Therefore, a chain tool 100, 300, 1300, or 1600 of the present disclosure may be used alone or in combination with another chain tool 100, 300, 1300, or 1600 depending on specific requirements of the application. Preferably, when two or more chain tools 100, 300, 1300, or 1600 are employed in an application, the chain tools 100, 300, 1300, or 1600 are forced to rotate in opposing directions such as a clockwise and a counter-clockwise direction to enable effective machining and removal of chips from a material. However, the chain tools 100, 300, 1300, or 1600 may be alternatively rotated in similar directions such as a clockwise direction, or a counter-clockwise direction to accomplish the machining and removal of chips from the material.

In view of the foregoing, it shall be evident that the present invention provides a unique system for constructing a modular, configurable, chain tool that facilitates wrapping a chain thereabout, as well as chain segments facilitating such modularity.

All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and may not create limitations, particularly as to the position, orientation, or use of the devices and/or methods disclosed herein. Joinder references (e.g., attached, coupled, connected, hinged, and the like) are to be construed broadly and may include intermediate members between a connection of segments and relative movement between segments. As such, joiner references do not necessarily infer that two segments are directly connected and in fixed relation to each other.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

Similarly, adjectives such as, but not limited to, “articulated”, “modified”, or similar, should be construed broadly, and only as nominal, and may not create any limitations, not create any limitations, particularly as to the description, operation, or use unless specifically set forth in the claims.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present disclosure as defined in the appended claims.

While certain exemplary embodiments have been described and shown in the accompanying drawings, it is to be understood that such embodiments are merely illustrative of and not restrictive on the broad present disclosure, and that this present disclosure not be limited to the specific constructions and arrangements shown and described, since various other modifications and/or adaptations may occur to those of ordinary skill in the art. It is to be understood that individual features shown or described for one embodiment may be combined with individual features shown or described for another embodiment. It is to be understood some features are shown or described to illustrate the use of the present disclosure in the context of functional segments and such features may be omitted within the scope of the present disclosure and without departing from the spirit of the present disclosure as defined in the appended claims.

1. A chain tool for chip removing and/or shredding, the chain tool comprising:
a tool body having a longitudinal axis, the tool body comprising:
a generally axi-symmetric envelope extending about the longitudinal axis and extending longitudinally between generally a first and a second end of the tool body each extending generally radially and being generally coaxially-aligned; and
a plurality of channels circumferentially defined on the envelope; and
a chain arranged about the tool body and linked therebetween, the chain comprising:
a plurality of chain members consecutively linked therebetween and disposed on the plurality of channels, wherein the chain members are configured to spiral circumferentially about the tool body from the first end to the second end.

2. The chain tool of claim 1, wherein each of the chain members comprises a substantially arcuate basal face configured to rest upon the plurality of channels.

3. The chain tool of claim 1, wherein the plurality of channels comprises:
a plurality of ridge faces; and
a plurality of groove faces, wherein the ridge faces and the groove faces alternate with each other.

4. The chain tool of claim 3, wherein a diameter of the groove face is less than a diameter of an adjacent ridge face.

5. The chain tool of claim 3, wherein the plurality of chain members comprises:
at least one keel member; and
at least one rider member linked to the keel member, wherein the keel members and the rider members alternate with each other, and wherein the rider members and the keel members abut the ridge faces and the groove faces respectively.

6. The chain tool of claim 5, wherein a width of the keel member and a width of the rider member correspond to a width of the ridge face and a width of the groove face, respectively.

7. The chain tool of claim 5, wherein the keel members and the rider members are linked by connectors such that a depth of the keel members measured from a center of the connectors to a basal face of the keel members is less than a depth of adjacent rider members measured from the center of the connectors to a basal face of the rider members.

8. The chain tool of claim 1, wherein each of the chain members comprises:
first and second sidewalls disposed substantially parallel to each other;
an outer side and an inner side laterally disposed to the first and second sidewalls; and
a pair of connectors disposed between the outer and inner sides, wherein a first connector is disposed adjacent to the first sidewall and a second connector is disposed adjacent to the second sidewall.

9. The chain tool of claim 8, wherein the connectors are swivel connectors configured to allow swivel movement between adjacent chain members.

10. The chain tool of claim 1, wherein the plurality of channels comprise alternating peaks and troughs linked by sloping sidewalls such that the sloped profile in a circumferential cross-section of the tool body.

11. The chain tool of claim 10, wherein each of the chain members comprise a basal face including:
a first slant face; and
a second slant face disposed in opposing relation to the first slant face such that the first and second slant faces are configured to rest upon the sloping sidewalls of the tool body; and
a keel edge defined at an intersection of the first and second slant faces, the keel edge configured to rest upon one of a peak and a trough of the tool body.

12. The chain tool of claim 1, wherein a pitch defined between adjacent channels of the tool body is one of equal and unequal, and wherein a length of the individual chain members is one of equal and unequal to correspond with the pitch between the channels of the tool body.

13. The chain tool of claim 1, wherein the tool body is modular, and comprises alternating and interfitting ridge rings and groove rings.

14. The chain tool of claim 1, wherein an outer side of at least one chain member defines an appendage adapted to accommodate a tool member.

15. The chain tool of claim 14, wherein two or more tool members on consecutive chain members define a tool configured to perform at least one of cutting, shredding, milling, broaching, and/or grinding.

16. A chain adapted to cooperate with a chain tool comprising alternate groove faces and ridge faces, the chain comprising:
a plurality of chain members consecutively linked to each other, the chain members comprising:
at least one keel member; and
at least one rider member linked to the keel member, wherein the keel members and the rider members alternate with each other to abut the ridge faces and the groove faces of the tool, respectively.

17. The chain of claim 16, wherein the keel members and the rider members are linked by connectors such that a depth of the keel members measured from a center of the connectors to a basal face of the keel members is less than a depth of an adjacent rider members measured from the center of the connectors to a basal face of adjacent rider members.

18. The chain of claim 16, wherein each of the chain members comprises a substantially arcuate basal face, the basal face comprising:
a plurality of keels extending away from the basal face, the keels configured to engage with the groove faces on; and
a plurality of ridges configured to engage with one or more groove faces and ridge faces of the chain tool.

19. A tool body of a chain tool comprising a plurality of channels including alternating peaks and troughs linked by sloping sidewalls such that the alternating peaks and troughs are configured to define a generally sloped profile in a circumferential cross-section of the tool body; and employing the chain of claim 16.

20. The chain of claim 19, wherein each of the chain members comprise a basal face including:
a first slant face; and
a second slant face disposed in opposing relation to the first slant face such that the first and second slant faces are configured to rest upon the sloping sidewalls of the tool body; and
a keel edge defined at an intersection of the first and second slant faces, the keel edge configured to rest upon one of a peak and a trough of the tool body.

21. The chain of claim 19, wherein a length of the individual chain members are one of equal and unequal to correspond with a pitch defined between adjacent channels of the tool body.

22. The chain of claim 16, wherein the outer side of at least one chain member defines an appendage adapted to accommodate a tool member.

23. The chain of claim 16, wherein a length of the keel member is greater than a length of the rider member.

24. The chain of claim 16, wherein a length of the keel member is lesser than a length of the rider member.

25. The chain of claim 16, wherein each of the chain members comprises:
first and second sidewalls disposed substantially parallel to each other;
an outer side and an inner side laterally disposed to the first and second sidewalls; and
a pair of connectors disposed between the outer and inner sides, wherein a first connector is disposed adjacent to the first sidewall and a second connector is disposed adjacent to the second sidewall.

26. The chain of claim 19, wherein the connectors are swivel connectors configured to allow swivel movement between adjacent chain members.
